(19) United States
(12) Patent Application Publication
(10) Pub. No.: US 2012/0221199 A1
(43) Pub. Date: Aug. 30, 2012

(54) VEHICLE-MOUNTED DISPLAY SYSTEM

(75) Inventor: KATSUYA SAITO, Aichi (JP)

(73) Assignee: PANASONIC CORPORATION, Osaka (JP)

(21) Appl. No.: 13/400,834

(22) Filed: Feb. 21, 2012

(30) Foreign Application Priority Data
Feb. 25, 2011 (JP) 2011-039782

(51) Int. Cl. G06F 17/00

(52) U.S. Cl. 701/36

(57) ABSTRACT

The present embodiment can provide a vehicle-mounted display system in which, when an operator operates console panels of steering switches at the same time, a control signal or a display signal corresponding to the simultaneous operations is output from a controller, thus varying displaying on a vehicle-mounted display. In this manner, the vehicle-mounted display system can cope with various operations.

### TECHNICAL FIELD

The technical field principally relates to a vehicle-mounted display system that varies displaying on a vehicle-mounted display.

### BACKGROUND ART

There has been recently developed a vehicle-mounted display system that varies displaying on a vehicle-mounted display when an operator operates a steering switch fixed to a steering wheel for a vehicle.

FIG. 13 is a view showing the configuration of a vehicle-mounted display system in the prior art.

Vehicle-mounted display system 10 includes steering switch 2, steering switch 3, and vehicle-mounted display 5.

Steering switch 2 is arranged on the right at a top surface of steering wheel 1 whereas steering switch 3 is arranged on the left at the top surface.

Icons 4 are displayed on a console panel of steering switch 2. Icons 4 correspond to “recirculation mode control,” “air delivery mode control,” “driver and passenger temperature control,” and the like, respectively of a vehicle-mounted air conditioner system.

When an operator moves his or her finger in contact with the console panel, steering switch 3 can detect the movement of the finger. Steering switch 3 is exemplified by a touch panel.

When the operator touches icon 4 on steering switch 2 corresponding to, for example, “vehicle inside temperature setting,” set temperature display 11 is displayed on vehicle-mounted display 5. In this state, the operator touches the console panel on steering switch 3 by the finger, and then, moves the finger forward, so that a numeral displayed on set temperature display 11 is incremented, thereby increasing a set temperature. To the contrary, when the operator moves the finger rearward, the numeral displayed on set temperature display 11 is decremented, thereby decreasing the set temperature.

The operator individually operates steering switches 2 and 3 so as to vary the displaying on vehicle-mounted display 5 in vehicle-mounted display system 10.

### SUMMARY

In a vehicle-mounted display system according to a preferred embodiment, when console panels on steering switches are operated at the same time, a control signal or a display signal corresponding to the simultaneous operations is output from a controller, so that displaying on a vehicle-mounted display is varied. In this manner, it is possible to provide the vehicle-mounted display system that can cope with various operations.

### BRIEF DESCRIPTION OF DRAWINGS

FIG. 1 is a view showing the configuration of a vehicle-mounted display system in a preferred embodiment;

FIG. 2 is an exploded perspective view showing a steering switch for use in the vehicle-mounted display system;

FIGS. 3A and 3B are views showing screens on a vehicle-mounted display on which displaying on the vehicle-mounted display system is varied;

FIG. 4 is a top view showing operation of the steering switch for the vehicle-mounted display system;

FIG. 5 is a view showing a screen on the vehicle-mounted display on which displaying on the vehicle-mounted display system is varied;

FIG. 6 is a top view showing operation of the steering switch for the vehicle-mounted display system;

FIGS. 7A and 7B are views showing screens on the vehicle-mounted display on which displaying on the vehicle-mounted display system is varied;

FIGS. 8A and 8B are top views showing operation of the steering switch for the vehicle-mounted display system;

FIGS. 9A and 9B are views showing screens on the vehicle-mounted display on which displaying on the vehicle-mounted display system is varied;

FIGS. 10A and 10B are top views showing operation of the steering switch for the vehicle-mounted display system;

FIGS. 11A and 11B are views showing screens on the vehicle-mounted display on which displaying on the vehicle-mounted display system is varied;

FIG. 12 is a top view showing operation of the steering switch for the vehicle-mounted display system; and

FIG. 13 is a view showing the configuration of a vehicle-mounted display system in the prior art.

### DETAILED DESCRIPTION OF THE PREFERRED EMBODIMENTS

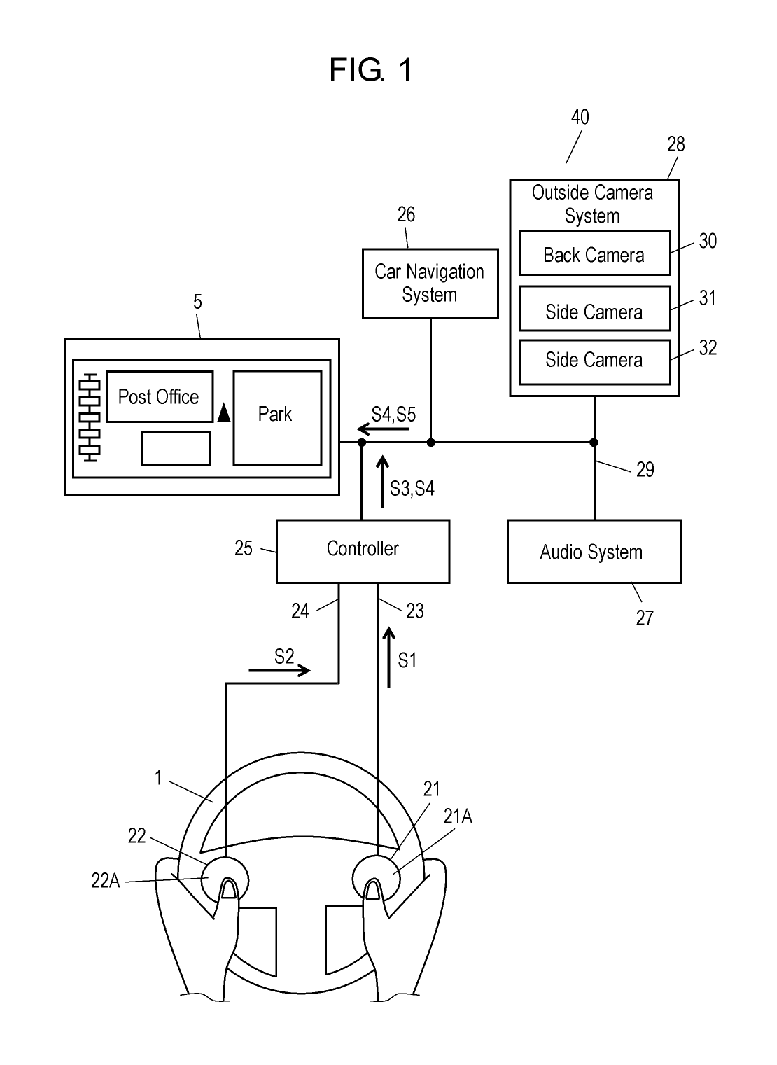

FIG. 1 is a view showing the configuration of a vehicle-mounted display system in a preferred embodiment. Steering wheel 1 is shown at a neutral position of a turn angle.

Vehicle-mounted display system 40 includes steering switch 21, steering switch 22, controller 25, car navigation system 26, audio system 27, outside camera system 28, and vehicle-mounted display 5.

Steering switch 21 is arranged slightly rightward with respect to a turn center at a top surface of steering wheel 1. In contrast, steering switch 22 is arranged slightly leftward with respect to the turn center at the top surface of steering wheel 1.

Steering switches 21 and 22 are exemplified by a capacitive touch panel for detecting the movement of a finger. When an operator touches consol panels 21A and 22A by the finger, and then, moves the finger in touch, steering switches 21 and 22 detect the movement of the finger.

Steering switches 21 and 22 are electrically connected to controller 25 via wirings 23 and 24, respectively. Controller 25 incorporates therein a semiconductor device such as a micro computer.

Controller 25 shall be preferably housed inside of a vehicular instrument panel. Controller 25 is electrically connected to car navigation system 26, audio system 27, outside camera system 28, vehicle-mounted display 5, and the like, via wiring 29. Here, examples of a vehicle-mounted network protocol include CAN (Controller Area Network), FlexRay, MOST (Media Oriented Systems Transport), and LIN (Local Interconnect Network).

Car navigation system 26 is adapted to display a map around the vehicle and the position of the vehicle on vehicle-mounted display 5 according to the operation of steering switches 21 and 22 by the operator. In this manner, car navigation system 26 assists the operator to drive the vehicle.

Audio system 27 is designed to select a musical composition to be played in a speaker, not shown, or a broadcast station according to the operation of steering switches 21 and 22 by the operator.

Outside camera system 28 includes, for example, back camera 30 for picking up the back view of the vehicle or side cameras 31 and 32 capable of picking up the vehicle on the right side view and left side view. Moreover, outside camera system 28 displays an image picked up by back camera 30 or side cameras 31 and 32 on vehicle-mounted display 5 according to the operation of steering switches 21 and 22 by the operator.

Vehicle-mounted display 5 is adapted to switch displaying of each of car navigation system 26, audio system 27, and outside camera system 28 according to the operation of steering switches 21 and 22 by the operator.

A description will be given below of a flow of a signal in vehicle-mounted display system 40 shown in FIG. 1.

Operation signals S1 and S2 according to the operations on the console panels 21A and 22A are input into controller 25 from steering switches 21 and 22, respectively.

Control signal S3 and display signal S4 are output from controller 25. Control signal S3 is adapted to control equipment such as car navigation system 26 or audio system 27. In contrast, display signal S4 is designed to control displaying on vehicle-mounted display 5.

Upon receipt of control signal S3, the equipment outputs display signal S5 to be displayed on vehicle-mounted display 5. Vehicle-mounted display 5 performs displaying in response to display signal S4 or display signal S5.

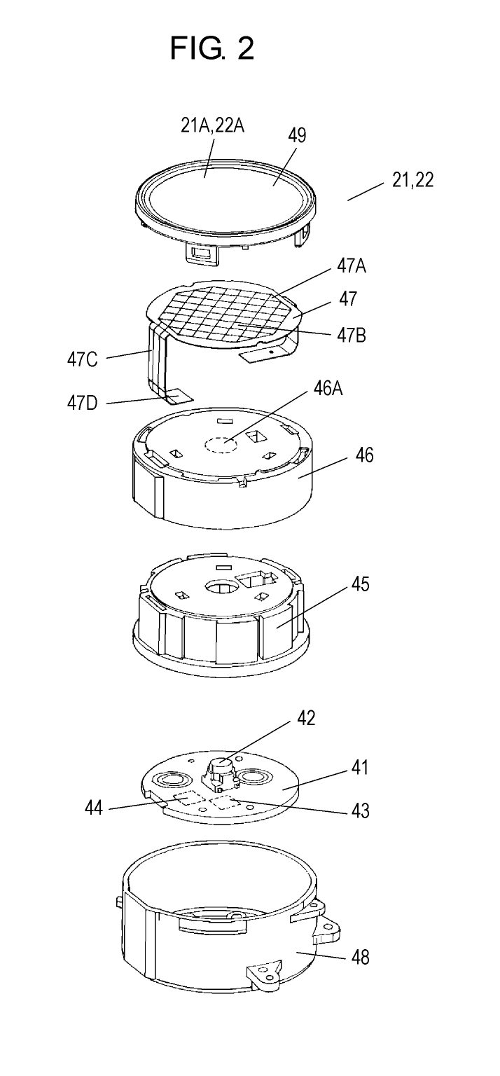

Steering switches 21 and 22 are exemplified by a steering switch shown in FIG. 2.

In this steering switch, push switch 42 is arranged substantially at a center of a top surface of a substantially circular wiring board 41 having wiring patterns formed on a top and a bottom thereof. When push switch 42 is depressed, it is turned on with a click feeling, and, in contrast, when it is released, it is automatically returned to the OFF state.

Control circuit 43 constituted of a semiconductor device such as a micro computer is disposed at a lower surface of wiring board 41. Connector 44 is arranged on the left of control circuit 43. Push switch 42 and connector 44 are electrically connected to control circuit 43 via the wiring pattern formed on wiring board 41.

Columnar box-shaped fixed cover 45 having an opening at a lower surface thereof is combined with columnar box-shaped movable cover 46 having an opening at a lower surface thereof. Electrode board 47 is placed at an upper surface of movable cover 46. Movable cover 46 and electrode board 47 can vertically move along fixed cover 45 integrally with each other.

Presser 46A formed into a columnar projection substantially at a center is disposed inside of movable cover 46 through fixed cover 45. Presser 46A is arranged in such a manner as to depress push switch 42.

Electrode board 47 is a flexible printed circuit board having a substantially circular sensor 47A at a center. Square electrodes 47B are disposed in a grid manner at an upper surface of sensor 47A. Electrodes 47B each are connected to terminal 47D via belt-like wires 47C.

Terminal 47D of electrode board 47 is connected to connector 44 through movable cover 46 and fixed cover 45.

Wiring board 41, fixed cover 45, movable cover 46, and electrode board 47 are contained inside lower cover 48 formed into a columnar box shape and having an upper opening, and then, electrode board 47 is fixed to movable cover 46 via substantially circular console plate 49.

When an operator moves a finger at the upper surface of console plate 49, that is, on console panels 21A and 22A in steering switches 21 and 22, control circuit 43 detects the movement of the finger by sensor 47A. Moreover, when the operator depresses console panels 21A and 22A by the finger, movable cover 46 descends, so that presser 46A depresses push switch 42. When the operator depresses console panels 21A and 22A by the finger, push switch 42 is turned on, and, in contrast, when the operator removes the finger from console panels 21A and 22A, push switch 42 is turned off.

When the operator individually operates steering switches 21 and 22, the displaying on vehicle-mounted display 5 is varied. Furthermore, also when the operator operates steering switches 21 and 22 at the same time, a screen displayed on vehicle-mounted display 5 is varied.

A description will be given of the variations of the displaying on vehicle-mounted display 5 when the operator operates steering switches 21 and 22 at the same time by way of some examples.

Explanation will be made on switching a map to be displayed on vehicle-mounted display 5 by car navigation system 26 in a first example.

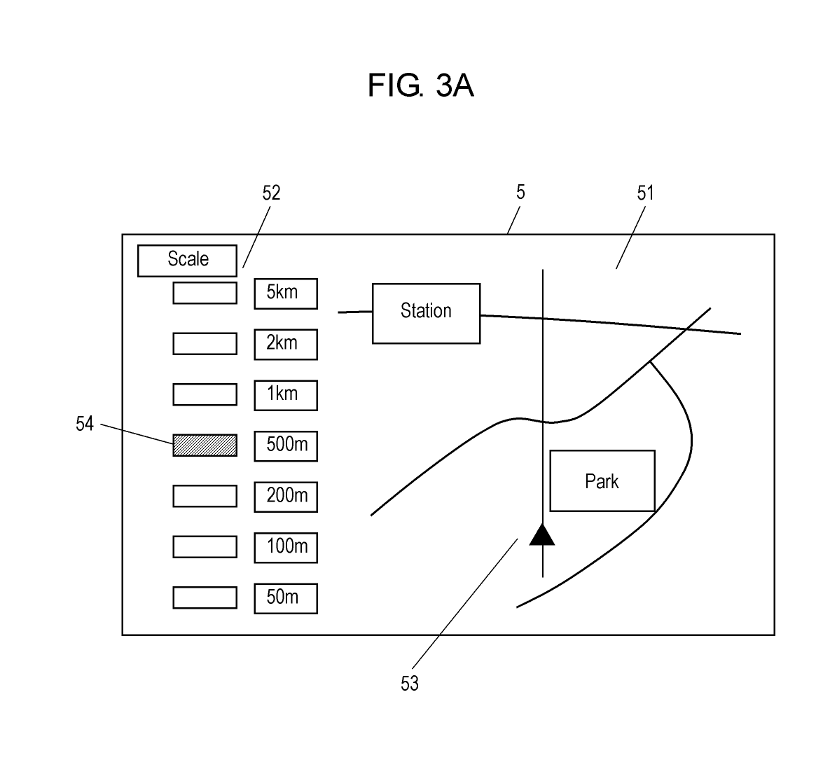

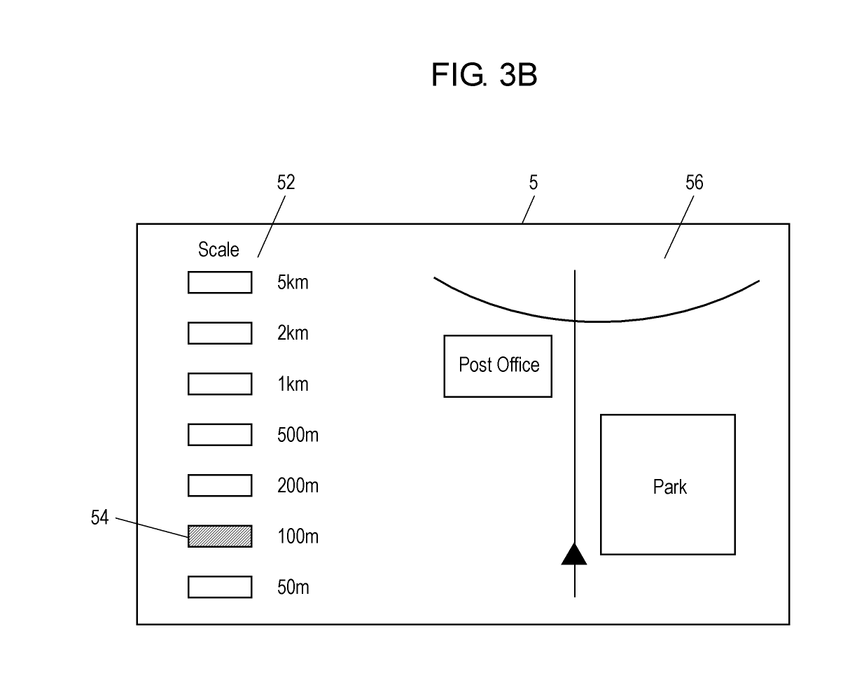

FIGS. 3A and 3B are views showing display screens on vehicle-mounted display 5 before and after operation shown in FIG. 4.

FIG. 4 is a top view showing operation of the steering switch for the vehicle-mounted display system.

In FIG. 3A, wide-area map image 51 and scale 52 are displayed on vehicle-mounted display 5. Icon 53 designates the vehicle by a solid black triangle on map image 51. Indicator 54 on scale 52 shows scales corresponding to map image 51.

Now, the scale of indicator 54 corresponds to 500 m. This scale corresponds to wide-area map image 51.

FIG. 4 shows slide operations of fingers of the operator in a direction indicated by arrow A (hereinafter referred to as rightward) on console panel 21A of right steering switch 21 and in a direction indicated by arrow B (hereinafter referred to as leftward) on console panel 22A of left steering switch 22. When the operator moves the right and left fingers in such a manner as to separate them apart from each other, the displaying shown in FIG. 3A is switched to displaying shown in FIG. 3B.

In FIG. 3B, map image 56 is shown in more detailed scale than map image 51. The scale of indicator 54 of scale 52 corresponds to, for example, 100 m. Map image 56 is enlarged in a scale five times that of map image 51.

A description will be given below of a flow of a signal when the displaying of vehicle-mounted display 5 is varied.

First, operation signals S1 and S2 are input into controller 25 from steering switches 21 and 22 operated by the operator at the same time. Next, controller 25 outputs control signal S3 to car navigation system 26, which then outputs, to vehicle-mounted display 5, display signal S5 including data for updating map image 51 to map image 56. And then, displaying of vehicle-mounted display 5 is updated to map image 56.

According to the operation for lengthening the interval between the right finger and the left finger of the operator, the scale of map image 51 is enlarged to that of map image 56, thus achieving the operation in conformity with the intention of the operator.

Since the operator can grip steering wheel 1 by the right and left hands while operates the switches, this system is suitable for a quick operation.

If the operator shortens the interval between the right and left fingers in the displaying shown in FIG. 3B, map image 56 on vehicle-mounted display 5 is returned to wide-area map image 51.

Explanation will be made on a second example, in which the map displaying on vehicle-mounted display 5 is turned by operating steering switches 21 and 22 at the same time.

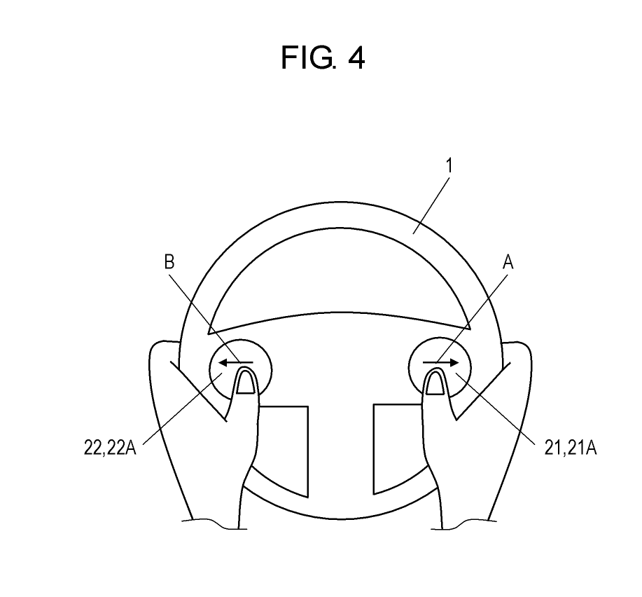

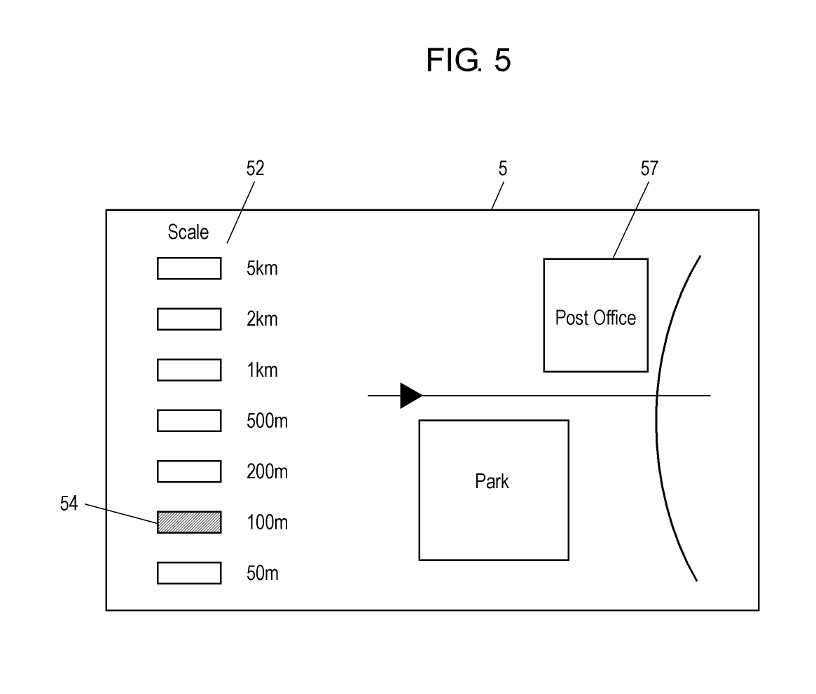

FIG. 5 shows a screen switched from the displaying shown in FIG. 3B by an operation shown in FIG. 6.

FIG. 6 is a top view showing operation of the steering switch for the vehicle-mounted display system.

FIG. 6 shows an operation for moving the finger in a direction indicated by arrow C (hereinafter referred to as rearward) on console panel 21A of steering switch 21 and in a direction indicated by arrow D (hereinafter referred to as forward) on console panel 22A of steering switch 22 by the operator. When the operator operates in this manner, map image 56 is turned clockwise, so that map image 57 is displayed.

According to the operation for moving the right and left fingers rearward and forward by the operator, map image 56 is turned to map image 57, and therefore, the system is suitable for a quick operation.

Explanation will be made on a third example, in which the equipment is switched by operating steering switches 21 and 22 at the same time.

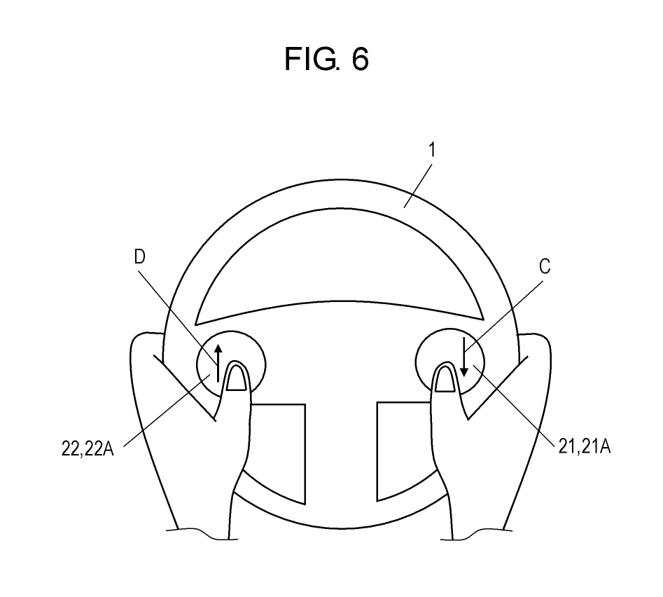

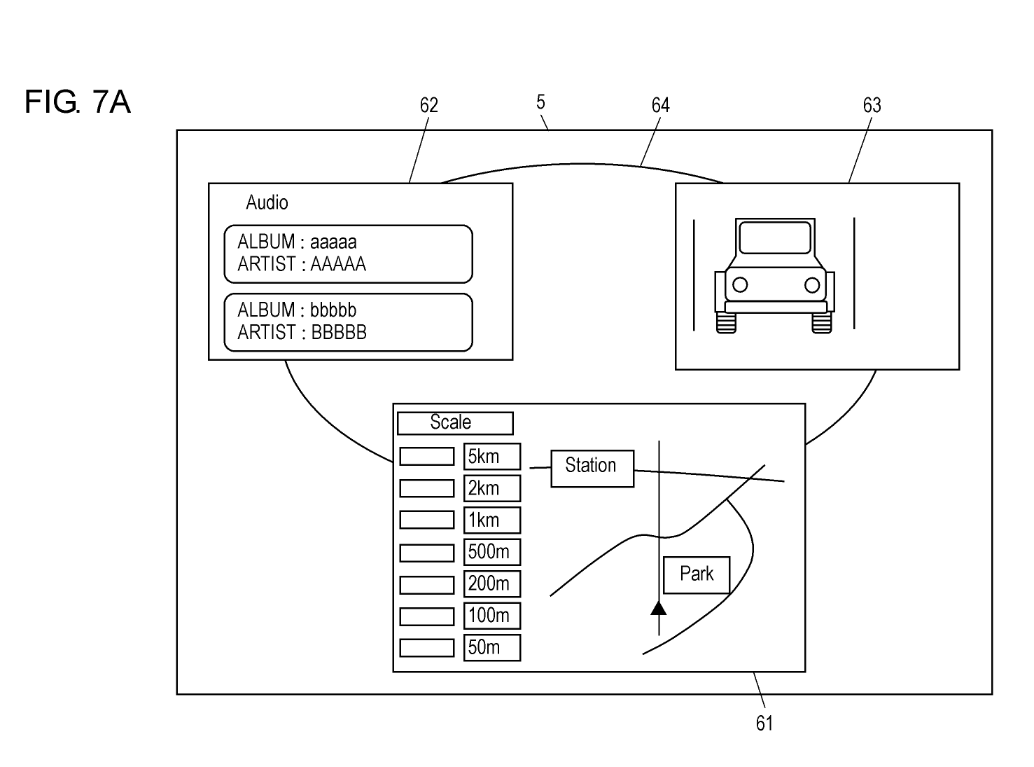

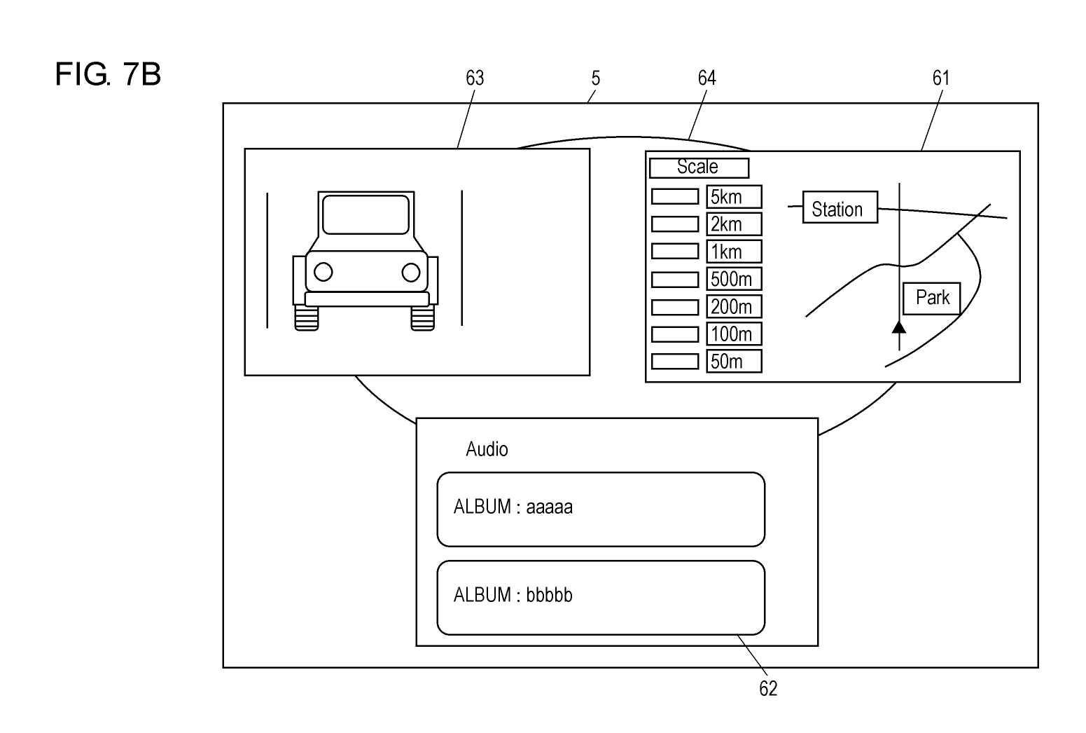

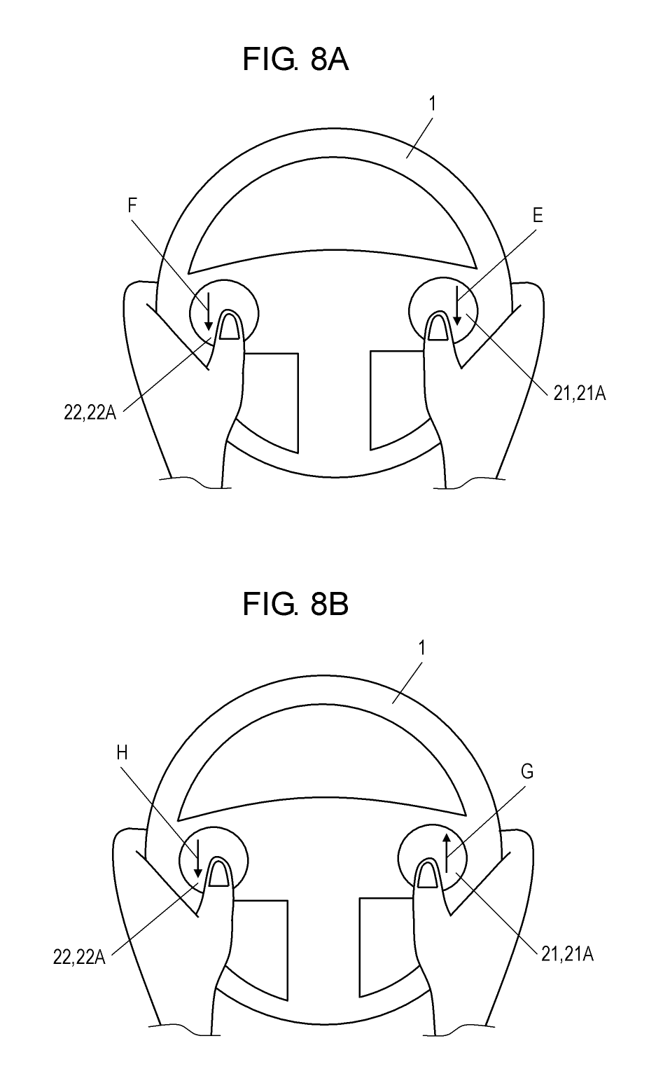

Here, FIG. 7A shows a screen switched from the screen shown in FIG. 3A by operation shown in FIG. 8A. FIG. 7B shows a screen switched from the screen shown in FIG. 7A by operation shown in FIG. 8B.

FIGS. 8A and 8B are top views showing operation of the steering switch for the vehicle-mounted display system.

FIG. 8A shows operation for moving the fingers in a direction indicated by arrow E (rearward) on console panel 21A of steering switch 21 and in a direction indicated by arrow F (rearward) on console panel 22A of steering switch 22 by the operator.

With this operation, the displaying shown in FIG. 3A is reduced in functional display 61 shown in FIG. 7A. Functional display 61 is displayed in a slightly lower portion on vehicle-mounted display 5. Functional display 62 representing audio system 27 and functional display 63 representing outside camera system 28 are displayed around functional display 61. Hence, functional displays 61, 62, and 63 are connected via ring-like wheel display 64.

Functional displays 61, 62, and 63 represent current control statuses of car navigation system 26, audio system 27, and outside camera system 28, respectively.

FIG. 8B shows operation for moving the fingers in a direction indicated by arrow G (forward) on console panel 21A of steering switch 21 and in a direction indicated by arrow H (rearward) on console panel 22A of steering switch 22 by the operator.

When the operator operates the steering switches shown in FIG. 8B at the time of the displaying shown in FIG. 7A, the displaying is switched to the displaying shown in FIG. 7B. Hence, functional displays 61, 62, and 63 are turned clockwise by one, and thus, functional display 62 representing audio system 27 is selected.

When the operator operates steering switch 21 in the direction indicated by arrow E and steering switch 22 in the direction indicated by arrow F in the first operation, the displaying before the operation is reduced to functional display 61. Thus, the operator can easily understand the status by intuition. In addition, functional displays 62 and 63 corresponding to the plurality of equipment such as audio system 27 and outside camera system 28 can be displayed at the same time. Thus, the system is suitable for the operation of the plurality of equipment.

In a next operation, when the operator operates steering switch 21 in the direction indicated by arrow G and steering switch 22 in the direction indicated by arrow H, functional displays 62 and 63 are displayed in turn along wheel display 64. In this manner, the equipment can be readily switched.

Explanation will be made on a fourth example, in which the displaying of audio system 27 is varied when steering switches 21 and 22 are operated at the same time.

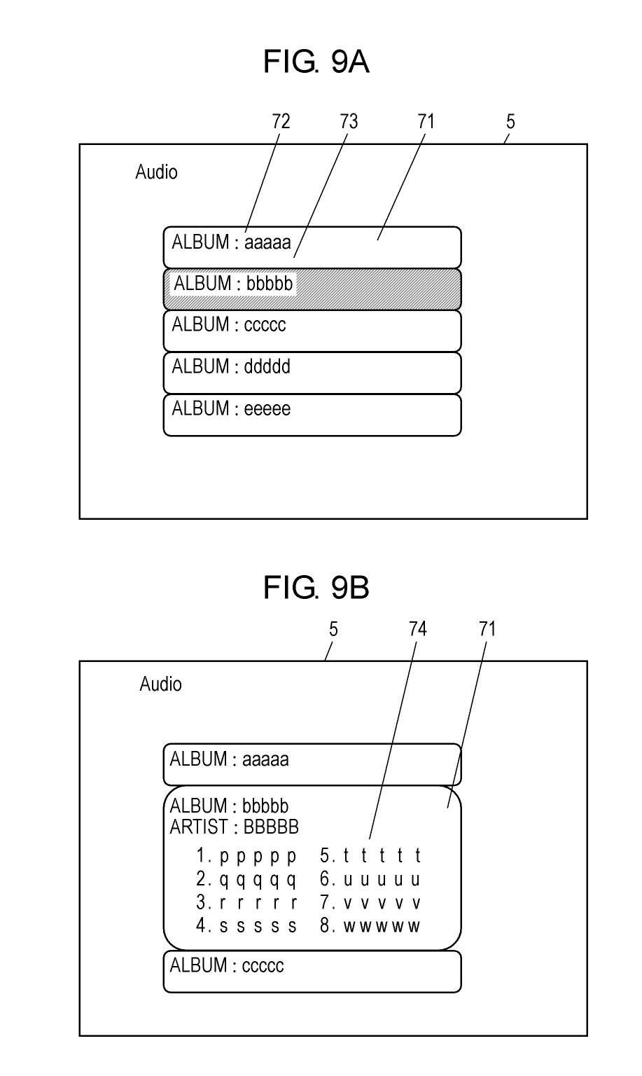

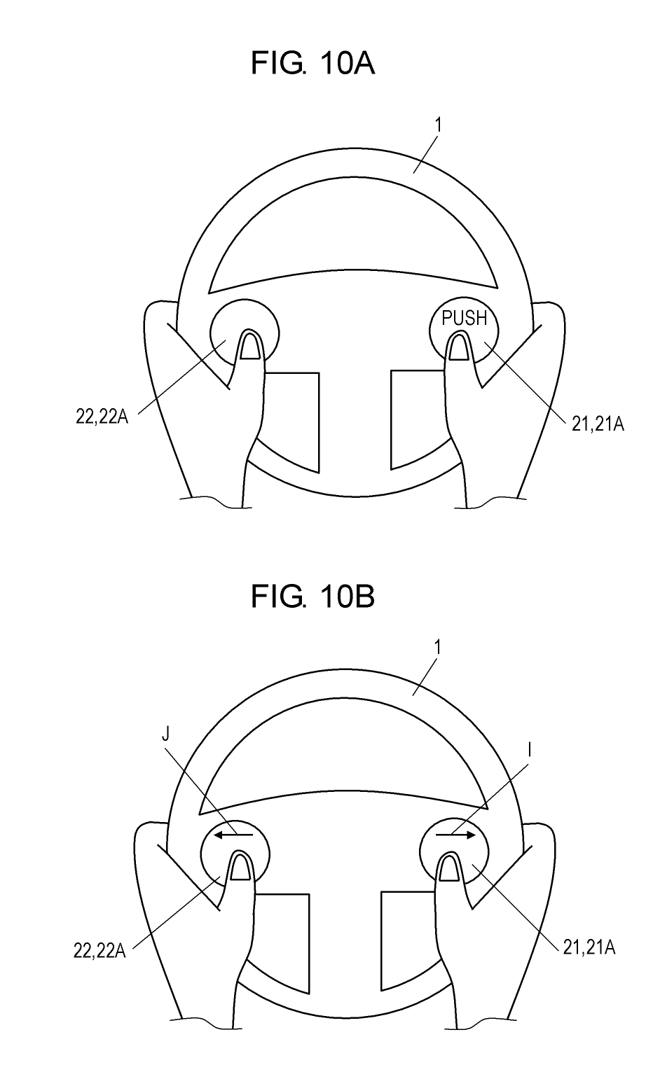

FIG. 9A shows a screen switched from the screen shown in FIG. 7B by operation shown in FIG. 10A. FIG. 9B shows a screen switched from the screen shown in FIG. 9A by operation shown in FIG. 10B.

FIGS. 10A and 10B are top views showing operation of the steering switch for the vehicle-mounted display system.

FIG. 10A shows operation of console panel 21A of steering switch 21 by the operator's finger.

With this operation, functional display 62 displayed at the slightly lower portion of vehicle-mounted display 5 shown in FIG. 7B is selected to be switched to a screen shown in FIG. 9A as an operational screen for audio system 27.

In FIG. 9A, album display 71 displays a collection consisting of a plurality of musical compositions. Album displays 71 include a plurality of titles 72 and a plurality of artist names 73.

If the operator moves the finger rearward on console panel 21A of steering switch 21, album display 71 selected is pulled down.

FIG. 10B shows operation for moving the finger in a direction indicated by arrow I (rightward) on console panel 21A of steering switch 21 and in a direction indicated by arrow J (leftward) on console panel 22A of steering switch 22 by the operator.

With this operation, as shown in FIG. 7B, a display area of album display 71 selected is enlarged, and then, the names of the plurality of musical compositions collected in album display 71 are displayed as musical composition display 74.

When the operator operates steering switches 21 and 22 at the same time, the area of album display 71 selected can be enlarged, so that the musical compositions in album display 71 can be displayed as musical composition display 74. Since steering switches 21 and 22 are operated in the directions indicated by arrows I and J (rightward and leftward), that is, in such a manner that the fingers are moved apart from each other, the operation conforms to the enlargement of the area by intuition.

Explanation will be made on the last example, in which the displaying of outside camera system 28 is varied when steering switches 21 and 22 are operated at the same time.

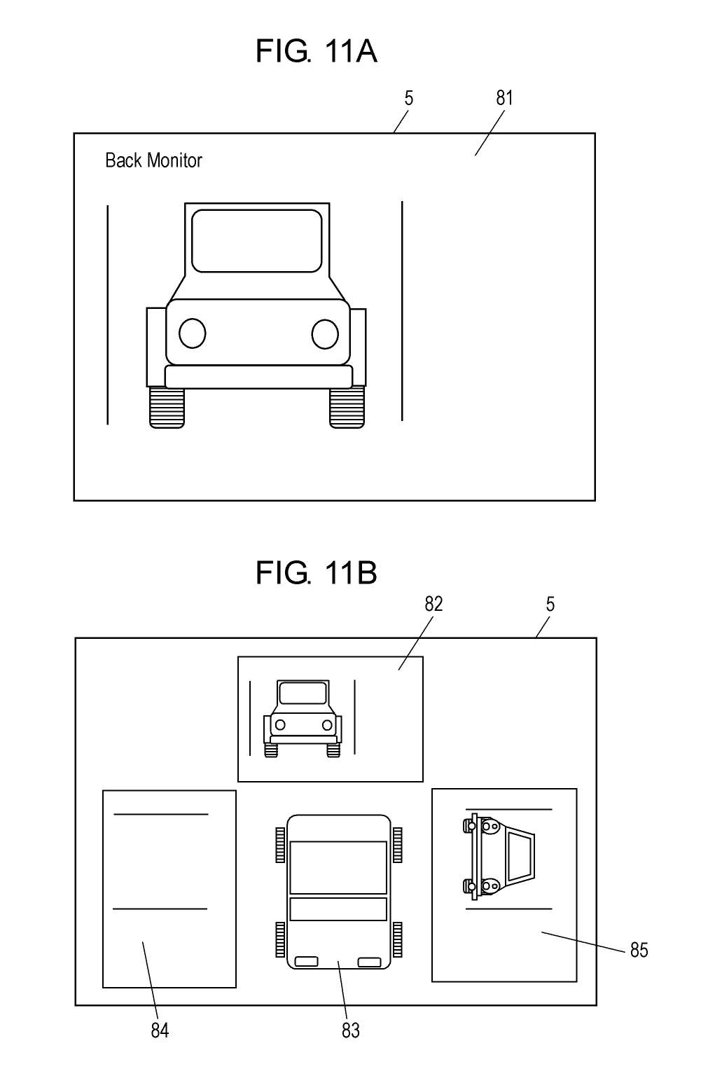

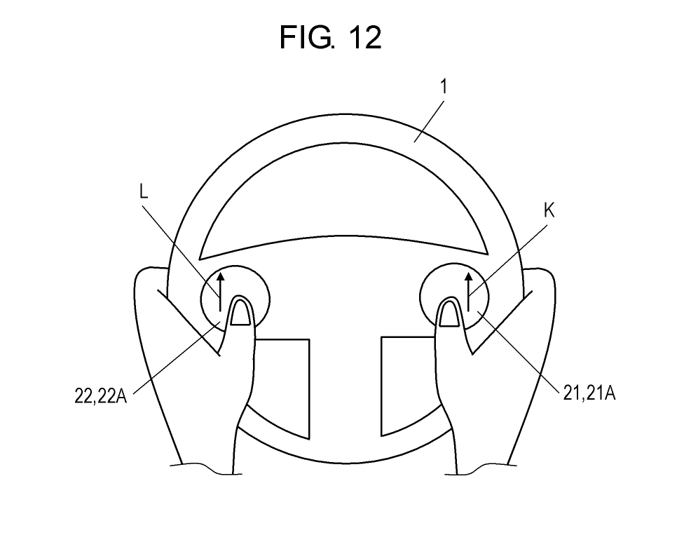

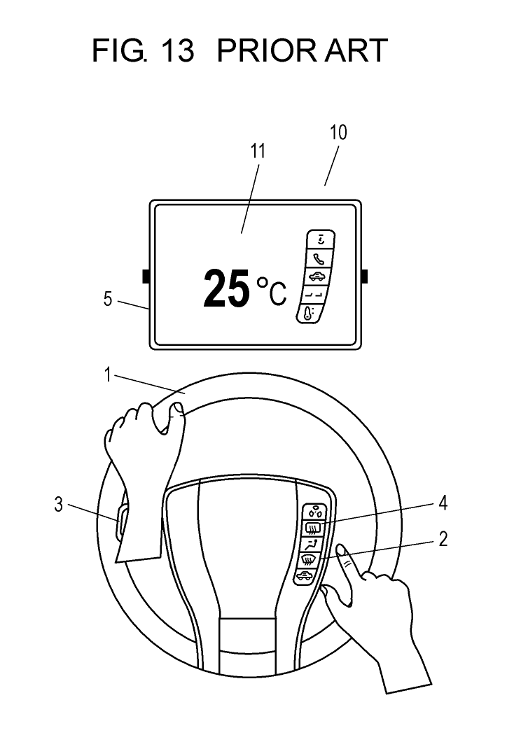

FIG. 11A shows a screen displaying a picture picked up by back camera 30 mounted on the vehicle. The screen is displayed when the vehicle travels backward, for example. FIG. 11B shows a screen after operation shown in FIG. 12 is performed in the display status shown in FIG. 11A.

FIG. 12 is a top view showing operation of the steering switch for the vehicle-mounted display system.

FIG. 12 shows operation for moving the finger in a direction indicated by arrow K on the console panel of steering switch 21 and in a direction indicated by arrow L on the console panel of steering switch 22 by the operator. With this operation, rear display 81 shown in FIG. 11A is reduced to rear display 82, as shown in FIG. 11B, and then, vehicle display 83 representing the vehicle under rear display 82 reduced and side displays 84 and 85 representing pictures picked up by right and left side cameras 31 and 32 rightward and leftward of vehicle display 83, respectively, are displayed on vehicle-mounted display 5.

The operator operates steering switches 21 and 22 at the same time, so that not only rear display 82 picked up by back camera 30 but also side displays 84 and 85 picked up by side cameras 31 and 32, respectively, are displayed on vehicle-mounted display 5. Hence, the displaying can be quickly displayed, as intended by the operator.

Although the description has been given of the exemplary case where rear display 81 becomes rear display 82 reduced by the simultaneous operations by steering switches 21 and 22, rear display 81 may not be reduced but be displayed in superimposition of side displays 84 and 85.

Although electrostatistic electrodes 47B are used as examples of steering switches 21 and 22 to detect the position of the finger in the above-described embodiment, any type of switches or functionally equivalent user input devices may be used as steering switches 21 and 22 as long as they can detect the movement of the finger or any other portion of the hand of the operator. For example, examples include a steering switch using a resistant film type touch panel, a steering switch for detecting an operational direction when a finger operates a globular or columnar roller, a steering switch for detecting an operational direction based on depression by push switches 42 mounted on wiring board 41, or an optical steering switch for detecting movement amount, direction, speed, or the like of a finger or a roller by using a light beam or a laser beam.

In the present preferred embodiment, the console panel of each of steering switches 21 and 22 may be formed into a polygon such as a circle and square, a rounded polygon, or ellipse as long as it can be operated.

In the present preferred embodiment, the fingers on the console panels of steering switches 21 and 22 may be variously moved in any directions such as forward, rearward, leftward, rightward, and slantwise or in such a manner as to draw an arcuate.

Operation signals S1 and S2 output from steering switches 21 and 22 may be configured to be input into controller 25 at the same time or with a lag in time series. In other words, they may be configured or transmitted in any manner as long as controller 25 can recognize the simultaneous operations of steering switches 21 and 22 based on the input of operation signals S1 and S2 into controller 25.

Vehicle-mounted display 5 may display symbols or icons at the same time in place of functional displays 61, 62, and 63. The equipment may be any system or device which can be used in the vehicle. Other examples of the equipment include an air-conditioner and a ventilation system inside of the vehicle.

Vehicle-mounted display 5 may display functional displays 61, 62, and 63 not separately but in superimposition. For example, vehicle-mounted display 5 does not display the functional display selected currently in a reduced scale by operating steering switches 21 and 22 but may display the functional displays not selected currently in superimposition.

What is claimed is:

1. A display system for mounting on a vehicle, the display system comprising:
first and second switches configured to be disposed on right and left portions, respectively, of a steering wheel, each of the first and second switches including a console panel exposed on a outer surface of the steering wheel;
a controller operable to receive operation signals output from the first and second switches;
an equipment system operable to receive a control signal output from the controller; and
a display device operable to receive a display signal output from the controller or the equipment system;
wherein when the respective console panels of the first and second switches are operated at a substantially simultaneous time, the control signal or the display signal indicating the substantially simultaneous operations is output from the controller and is used to vary a display of the display device.

2. The display system according to claim 1, wherein a plurality of equipment systems are provided; and
when the console panels of the first and second switches are operated at the substantially simultaneous time in a state in which a functional display corresponding to one of the plurality of equipment systems is displayed on the display device, a functional display corresponding to another one of the equipment system is additionally displayed on the display device.

3. The display system according to claim 1, wherein a plurality of equipment systems are provided; and
when the console panels of the first and second switches are operated at the substantially simultaneous time in a state in which functional displays or icons corresponding to the plurality of equipment systems are displayed on the display device, positions where the functional displays or icons corresponding to the plurality of equipment systems are displayed on the display device are varied.

4. The display system according to claim 1, wherein the equipment system is a car navigation system; and
when the console panels of the first and second switches are operated at the substantially simultaneous time in a state in which a map image is displayed on the display device, a scale of the displayed map image is varied in response to a display signal output from the car navigation system.

5. The display system according to claim 1, wherein the equipment system is an audio system; and
when the console panels of the first and second switches are operated at the substantially simultaneous time in a state in which a plurality of album displays are displayed on the display device, a plurality of musical composition displays corresponding to one selected album display are displayed on the display device in response to a display signal output from the audio system.

6. The display system according to claim 1, wherein the equipment system is an outside camera system, the outside camera system including a back camera operable to pick up a back view image of a vehicle and side cameras operable to pick up left and right side view images of the vehicle; and
when the console panels of the first and second switches are operated at the substantially simultaneous time in a state in which the back view image of the vehicle picked up by the back camera is displayed on the display device, left and right side view image displays picked up by the side cameras are additionally displayed on the display device along with the back view image display picked up by the back camera.

7. A display system for mounting on a vehicle, the display system comp rising:
first and second user input devices configured to be disposed on right and left portions, respectively, of a steering wheel, the first and second user input devices operable to receive inputs from any portion of a user's left and right hands, respectively;
a controller operable to receive operation signals output from the first and second user input devices;
an equipment system operable to receive a control signal output from the controller; and
a display device operable to receive a display signal output from the controller or the equipment system;
wherein when the first and second user input devices receive inputs from the user at a substantially simultaneous time, the control signal or the display signal indicating the substantially simultaneous operations is output from the controller and is used to vary a display of the display device.

8. The display system according to claim 7, wherein when the first and second user input devices receive inputs from the user at a substantially simultaneous time, the control signal or the display signal indicating the substantially simultaneous operations is output from the controller and is used to either expand a current display of the display device to provide greater detail or collapse a current display of the display device to provide less detail.

9. The display system according to claim 8, wherein a plurality of equipment systems are provided; and
wherein when the first and second user input devices receive inputs from the user at a substantially simultaneous time in a state in which a functional display corresponding to one of the plurality of equipment is selected on the display device, the selection is changed such that the functional display corresponding to another one of the plurality of equipment is selected on the display device.

10. The display system according to claim 9, wherein the plurality of equipment systems include a car navigation system, an outside camera system or an audio system.
